(19) United States
(12) Patent Application Publication
(10) Pub. No.: US 2004/0015879 A1
(43) Pub. Date: Jan. 22, 2004

(54) Method and apparatus for tracing details of a program task

(75) Inventors: Wim De Pauw, Scarborough, NY (US); Nick Mitchell, Yorktown Heights, NY (US); Martin Robillard, Vancouver (CA); Gary Sevitsky, New York, NY (US); Harini Srinivasan, Tarrytown, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 10/040,344

(22) Filed: Jan. 2, 2002

Related U.S. Application Data
(60) Provisional application No. 60/278,538, filed on Mar. 23, 2001.

(51) Int. Cl. G06F 9/44

(52) U.S. Cl. 717/127; 717/128

(57) ABSTRACT

A method and apparatus are disclosed for analyzing one or more program tasks associated with a software system. A program task-oriented tracing and analysis technique allows detailed information to be gathered and analyzed for one or more specified program tasks. A user can iteratively vary the level of detail or the selected program task(s) of interest, or both, until the source of a problem is identified. For each program task under analysis, the user can define what commences a task and what concludes a task. A software program is monitored until the user-specified criteria for commencing a task is identified and continues to trace the execution of the software program until the user-specified criteria for concluding a task is identified.

### CROSS REFERENCE TO RELATED APPLICATION

This application claims the benefit of U.S. Provisional Application No. 60/278,538, filed Mar. 23, 2001.

### FIELD OF THE INVENTION

The present invention relates generally to techniques for monitoring and debugging software programs and, more particularly, to methods and apparatus that generate a trace that permits the operation of a software program to be analyzed.

### BACKGROUND OF THE INVENTION

Understanding the behavior of a complex software program, such as a transaction server for an e-commerce application, often requires a balance between the level of detail and the volume of information that is analyzed. For example, a transaction server may perform poorly because it does not always precompile a database query. Establishing this piece of information requires a relatively fine level of detail. In particular, the person evaluating the performance of the software program must have access to the sequence, context, and duration of individual method invocations.

A number of analysis tools for software programs have been developed that monitor the execution of a software program and generate a trace that may be analyzed to determine the source of errors or inefficient performance. For example, various analysis tools exist that allow a programmer to insert debugging code into specific portions of a software program that will create an entry in a trace each time the inserted portions of the code are executed. Unfortunately, recording detailed execution traces in this manner quickly becomes infeasible, due to both space overheads and time perturbations, even for only reasonably complex programs. For example, tracing the Jinsight™ visualizer, available from IBM Corporation, consumes approximately 37 megabytes (MB) of memory by the time the main window of the Jinsight™ application has appeared, even when certain values, such as argument and return values, are not included in the trace. In addition to consuming valuable memory resources, the traces are too large to be analyzed in an effective manner. Furthermore, such detailed tracing slows down and interrupts the execution of the monitored program, thus potentially leading to time perturbations including how the monitored program interacts with other programs.

Other software analysis tools have been developed that have attempted to overcome this limitation by aggregating statistics about the operation of the software program. Generally, such analysis tools employ counters or other metrics that monitor various statistics about the operation of the program, such as heap consumption, method invocation counts and the average invocation time for each method. Such aggregate statistics, however, will mask the sequence and concurrency of events. Thus, these analysis tools have proved to be ineffective in assisting with the determination of a root problem for a software program.

A need therefore exists for a task-oriented software analysis tool that generates a trace for a selected program task. Another need exists for a software analysis tool that provides a variable level of detail associated with one or more selected program tasks. Yet another need exists for a software analysis tool that allows a user to iteratively vary the level of detail and the selected program task(s) of interest until the source of a problem is identified

### SUMMARY OF THE INVENTION

Generally, a method and apparatus are disclosed for analyzing one or more program tasks associated with a software system. The disclosed program task-oriented tracing and analysis technique allows detailed information to be gathered and analyzed for one or more specified program tasks. The present invention allows a user to iteratively vary the level of detail or the selected program task(s) of interest, or both, until the source of a problem is identified.

For each program task under analysis, the user can define what commences a task and what concludes a task. Generally, the disclosed software analysis tool monitors the execution of a software program until the user-specified criteria for commencing a task is identified and continues to trace the execution of the software program until the user-specified criteria for concluding a task is identified.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram showing an exemplary network environment in which a software analysis tool in accordance with the present invention can operate;

FIG. 2 is a sample table from an exemplary trace generated by the software analysis tool of FIG. 1;

FIG. 3 is a flow chart describing an exemplary tracing process incorporating features of the present invention; and

FIG. 4 illustrates a graphical user interface that may be employed in accordance with the present invention to specify both the task of interest and the details associated with that task to be used to trace each selected program task.

### DETAILED DESCRIPTION OF PREFERRED EMBODIMENTS

The present invention recognizes that many program tasks performed by a software program are repetitive in nature. For example, an online banking server program continually processes a fixed set of transactions (e.g., buy, sell and exchange) and an analysis tool program reads in traces (a large number of events, but containing only a few event types). Thus, when such a repetitive software program is monitored over time, similar repeated program tasks will generally be observed, such as multiple buy orders for the online banking example. The present invention recognizes that each of the similar repeated program tasks include substantially similar operations. Thus, to trace each of the similar repeated program tasks will yield a significant amount of duplicative data. Thus, the present invention provides program task-oriented tracing and analysis technique that allow detailed information to be gathered and analyzed for one or more specified program tasks.

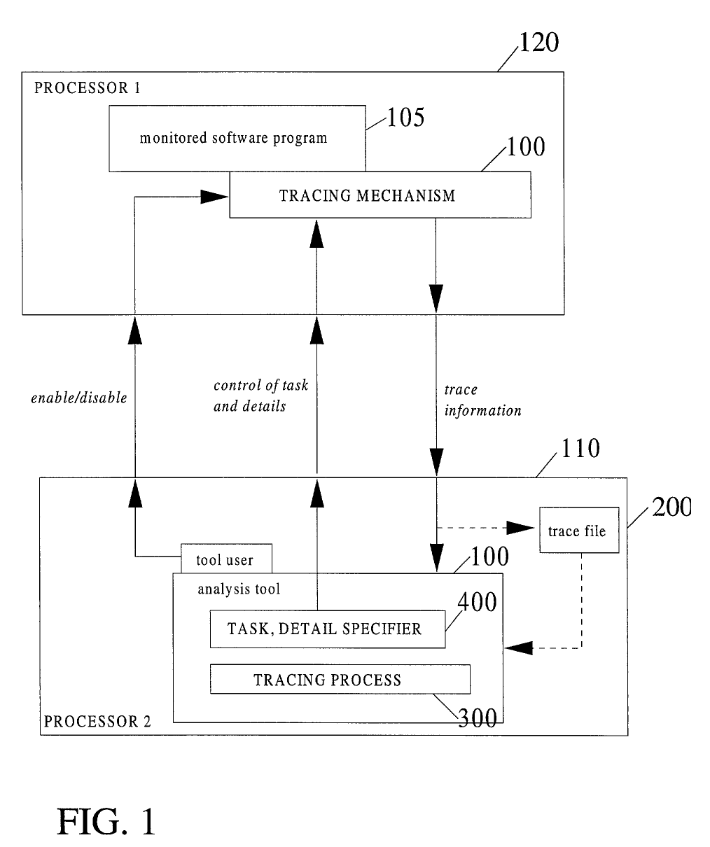

FIG. 1 illustrates a software analysis tool 100 that performs tracing of a software program 105 in accordance with the present invention. As shown in FIG. 1, the monitored software program 105 may be executing on a remote processor 120. A burst is a set of trace execution information gathered during an interval of time, associated with a specific program task in a program. Consider a transaction server, where many types of transaction may be in progress at the same time, with each transaction most likely at a different stage of its work. A user of the software analysis tool 100, however, may only be interested in the database activity associated with a specific transaction. A user can direct the analysis tool 100 to show a subset of the execution space corresponding to just those invocations that perform database operations when called from specific program tasks.

According to another aspect of the invention, the user can vary the level of detail or the selected program task(s) of interest, or both, using an iterative analysis process until the source of a problem is identified. In this manner, the user can validate or disprove each hypothesis about where a problem may be present. Typically, for each iteration, a user formulates a hypothesis, embodies this hypothesis in tracing specifications (e.g., a level of detail for each selected program task), requests any number of trace bursts, validates the hypothesis, and finally updates the current hypothesis.

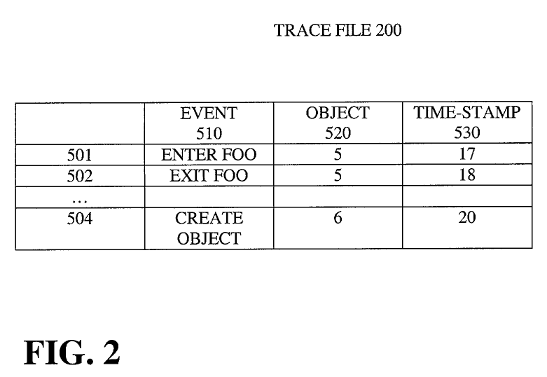

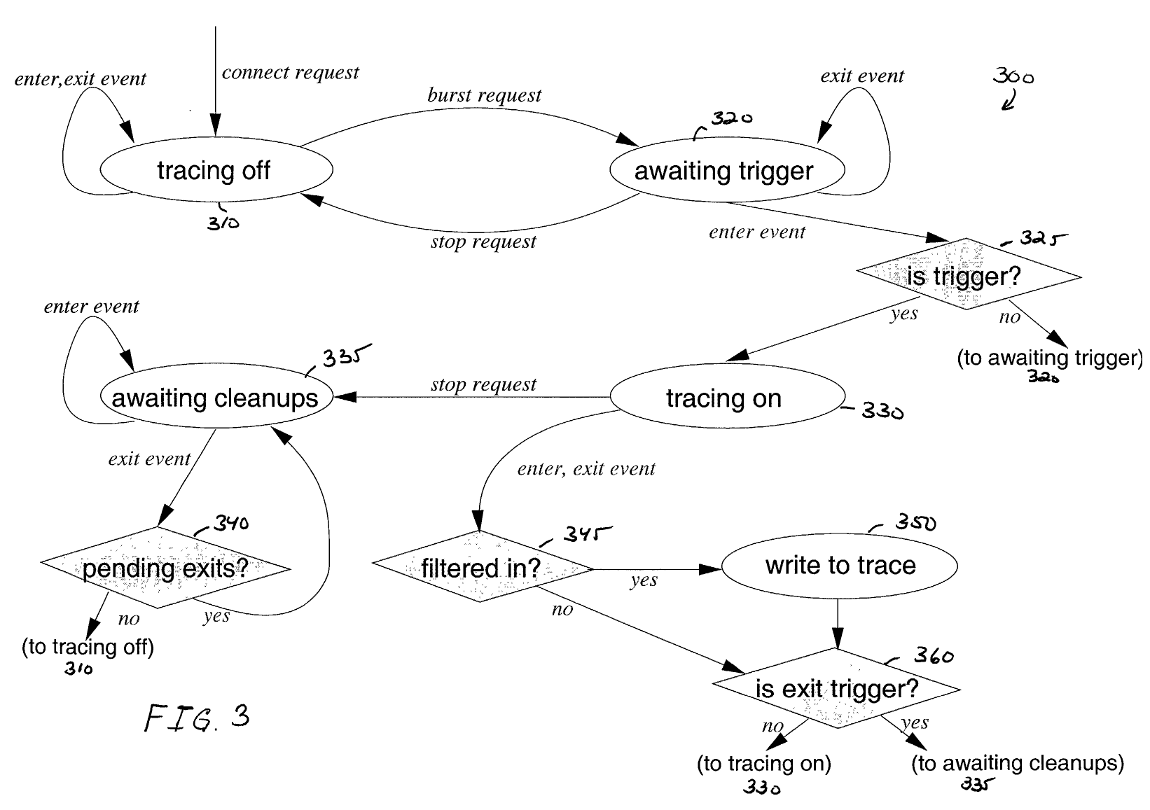

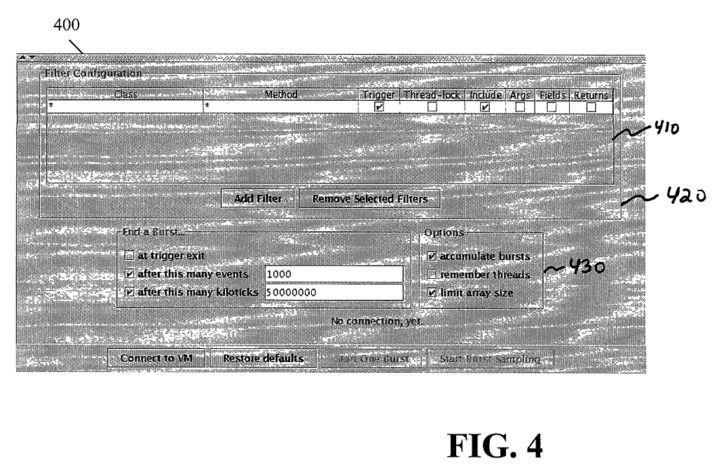

According to another aspect of the invention, discussed further below in conjunction with FIGS. 3 and 4, for each program task under analysis, the user can define what commences a task and what concludes a task. Thus, the software analysis tool 100 will begin tracing only when the user-specified conditions for commencing a task are present. While tracing, the software analysis tool 100 creates an entry in a trace 200, discussed below in conjunction with FIG. 2, for certain predefined events that may include, e.g., invocations and value information for only those filtered methods in the requested threads. Finally, the software analysis tool 100 will terminate the trace when the user-specified criteria to conclude tracing is encountered.

The present invention recognizes that successful analysis does not require fine detail all the time, nor about every aspect of the execution of a software program. For example, consider a graphical application with a problem redrawing, where the drawing canvas sometimes zooms as expected, but other times does not. To diagnose this problem, a debugger need not collect information about every invocation, but only enough to shed sufficient light on the control context (e.g., “the redraw fails only when preceded by calls which reset the scaling parameters”) and the data context (e.g., “sometimes the program loses precision when converting from doubles to integers”).

Rather, the level of detail required depends both on the analysis at hand, and on the tool user's current level of understanding. In either case, it is the tool user who can best establish what, of the huge amount of possible information, to record. For example, the user may initially not even know the names of relevant routines. At this point, the user is not interested in seeing a lot of detail in the trace that would include, for example, argument values. Eventually, though, the user may need to know such fine details. In fact, as the iterative analysis process continues, the tool user may know, for example, that it is only a particular argument of a certain invocation that is interesting (and not any other argument of other methods).

FIG. 1 is a block diagram showing the architecture of an illustrative software analysis tool 100 in accordance with the present invention. The software analysis tool 100 may be embodied as a general purpose computing system, such as the general purpose computing system shown in FIG. 1. The software analysis tool 100 includes one or more processors 110, 120 and related memory, such as a data storage device, which may be distributed or local. The processor may be embodied as a single processor, or a number of local or distributed processors operating in parallel. The data storage device and/or a read only memory (ROM) are operable to store one or more instructions, which the processor is operable to retrieve, interpret and execute.

In the exemplary embodiment shown in FIG. 1, the software analysis tool 100 is executing on a first processor 110 and is remotely monitoring a software program 105 executing on a second remote processor 120. In such a remote embodiment, the software analysis tool 100 can use a live connection in order to analyze running programs executing on a remote server. This aspect is critical when analyzing server systems in their typical, heavily loaded, state. When analyzing a complex, distributed application, the system cannot be halted, as a traditional debugger would. This would likely cause network timeouts, bringing the system into some undesirable state. Also, it is not feasible to halt the system and restart it to validate every new hypothesis. Thus, the techniques of the present invention require attaching/detaching and reconnecting to running servers. Further, for a remote customer site in its production state, it is advantageous to have a low-bandwidth and low-perturbation analysis tool.

As shown in FIG. 1, the software analysis tool 100 generates a trace 200, discussed below in conjunction with FIG. 2, that stores the trace execution information gathered during a specified interval of time, associated with a specific program task in a program. In addition, the software analysis tool 100 includes a user interface 400, discussed further below in conjunction with FIG. 4, and a tracing process 300, discussed below in conjunction with FIG. 3. Generally, the tracing process 300 monitors the execution of the software program 150 until the user-specified criteria for commencing a task is identified and continues to trace the execution of the software program until the user-specified criteria for concluding a task is identified.

FIG. 2 is a sample table from an exemplary trace 200. Generally, each trace 200 contains a list of events and a corresponding time stamp. The event may specify an associated object and an operation performed on the object. The exemplary trace 200 shown in FIG. 2 includes a plurality of records, such as records 501-504, each corresponding to a different trace event. For each event, the trace 200 identifies the event in field 210 and the corresponding object and time stamp in fields 220 and 230, respectively.

It is noted that the trace 200 may be processed by a visualizer, such as the Jinsight™ visualizer, commercially available from IBM Corporation, to obtain a more useful representation of the traced information, in a known manner.

FIG. 3 is a flow chart describing an exemplary tracing process 300 incorporating features of the present invention. As previously indicated, the tracing process 300 monitors the execution of the software program 150 until the user-specified criteria for commencing a task is identified and continues to trace the execution of the software program until the user-specified criteria for concluding a task is identified. As shown in FIG. 3, the tracing process 300 is initially in a “tracing off” mode 310 until a burst request is received from the user using the graphical user interface 400, discussed below in conjunction with FIG. 4.

When a burst request is received, the tracing process 300 enters a mode 320 where it is awaiting a trigger (i.e., a user-specified commencement event). The tracing process 300 will remain in the “awaiting trigger” mode 320 until (i) a stop request is received from the user, whereupon the tracing process 300 will return to the “tracing off” mode 310; or (ii) an event is detected. If an event is detected, a test is performed during step 325 to determine if the event is a user-specified trigger event. If it is determined during step 325 that the event is not a user-specified trigger event, then program control returns to step 325 to await the next event.

If, however, it is determined during step 325 that the event is a user-specified trigger event, then program control proceeds to step 330, where tracing is activated. The tracing process 300 will continue tracing until (i) a stop request is received from the user, whereupon the tracing process 300 will proceed to a “cleanup” mode 335; or (ii) an event is detected. If an event is detected, a test is performed during step 345 to determine if the user has specified that such events should be traced. If it is determined during step 345 that the event is not filtered in, then program control proceeds to step 360. If, however, it is determined during step 345 that the event is filtered in, then the event is written to the trace 200 during step 350.

A test is performed during step 360 to determine if the event is an exit trigger. If it is determined during step 360 that the event is an exit trigger, then program control proceeds to a “cleanup” mode 335. If, however, it is determined during step 360 that the event is not an exit trigger, then program control returns to the “tracing on” mode 330 to continue tracing subsequent events.

As previously indicated, the tracing process 300 will enter a “cleanup” mode 335 when a stop request is received from the user during tracing, or when an exit trigger is detected. During the “awaiting cleanup” mode 335, each event is processed to determine if it is an exit event. A test is performed during step 340 to determine if there are additional pending exits to be processed. If it is determined during step 340 that there are additional pending exits to be processed, then program control returns to step 335. If, however, it is determined during step 340 that there are no additional pending exits to be processed, then program control returns to the tracing off mode 310.

FIG. 4 illustrates a graphical user interface 400 that may be employed in accordance with the present invention to specify both the task of interest and the details associated with that task to be used to trace each selected program task. As shown in

FIG. 4, the exemplary graphical user interface 400 includes a region 410 that allows a user to specify the events to be traced, and the scope of the information to be traced, such as whether to include arguments and return values in the trace. In addition, the exemplary graphical user interface 400 includes a region 420 that allows a user to add or remove filters for the trace. Finally, the exemplary graphical user interface 400 includes a region 430 that allows a user to define the exit triggers that determine when a particular trace should terminate.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for analyzing behavior of a software system, comprising:
collecting details associated with a program task associated with said software system; and
providing said collected details for analysis.

2. The method of claim 1, wherein a duration of said program task is defined by one or more conditions associated with a state of said software system.

3. The method of claim 2, wherein said one or more conditions includes an entry or exit of at least one specified method.

4. The method of claim 2, wherein said one or more conditions includes a creation or deletion of at least one specified object.

5. The method of claim 2, wherein said one or more conditions includes an invocation of at least one specified object.

6. The method of claim 2, wherein said one or more conditions includes a passing of at least one specified object or scalar value as an argument, return value or field value.

7. The method of claim 2, wherein said one or more conditions includes at least one specified sequence of method invocations.

8. The method of claim 2, wherein said one or more conditions includes at least one specified resource exceeding at least one specified threshold.

9. The method of claim 1, wherein said collected details include an existence or sequence of specified method invocations.

10. The method of claim 1, wherein said collected details include an existence or sequence of specified object creations and deletions.

11. The method of claim 1, wherein said collected details include an existence or sequence of specified class loading and unloading.

12. The method of claim 1, wherein said collected details include values of specified arguments to invocations of specified methods.

13. The method of claim 1, wherein said collected details include values of specified return values from invocations of specified methods.

14. The method of claim 1, wherein said collected details include values of specified field values for invoked objects or field values for passed arguments.

15. The method of claim 1, further comprising the step of collecting said details for at least one specified number of task instances.

16. The method of claim 1, further comprising the step of collecting said details for at least one specified number of threads.

17. The method of claim 1, further comprising the step of dynamically modifying said program task specification associated with said analysis in an iterative process.

18. The method of claim 1, further comprising the step of dynamically modifying a specification of which details to collect in an iterative process.

19. The method of claim 1, further comprising the step of connecting to a running version of said software system.

20. The method of claim 1, further comprising the step of visually analyzing said collected details.

21. The method of claim 1, further comprising the step of visually analyzing said collected details for a plurality of instances of said program task.

22. The method of claim 1, further comprising the step of quantitatively analyzing said collected details.

23. The method of claim 1, further comprising the step of quantitatively analyzing said collected details for a plurality of instances of said program task.

24. A method for tracing details associated with a program task executing in a software system, comprising:
monitoring said soft ware system to identify said program task; and
tracing details associated with said program task.

25. The method of claim 24, wherein a duration of said program task is defined by one or more conditions associated with a state of said software system.

26. The method of claim 25, wherein said one or more conditions is selected from the group consisting essentially of (i) an entry or exit of at least one specified method, (ii) a creation or deletion of at least one specified object, (iii) an invocation of at least one specified object, (iv) a passing of at least one specified object or scalar value as an argument, return value or field value, (v) at least one specified sequence of method invocations, and (vi) at least one specified resource exceeding at least one specified threshold.

27. The method of claim 24, wherein said collected details include at least one of the following: (i) an existence or sequence of specified method invocations, (ii) an existence or sequence of specified object creations and deletions, (iii) an existence or sequence of specified class loading and unloading, (iv) values of specified arguments to invocations of specified methods; (v) values of specified return values from invocations of specified methods, and (v) values of specified field values for invoked objects or field values for passed arguments.

28. The method of claim 24, further comprising the step of collecting said details for at least one of at least one specified number of task instances and at least one specified number of threads.

29. The method of claim 24, further comprising the step of dynamically modifying said program task specification associated with said analysis in an iterative process.

30. The method of claim 24, further comprising the step of dynamically modifying a specification of which details to collect in an iterative process.

31. The method of claim 24, further comprising the step of connecting to a running version of said software system.

32. A system for analyzing behavior of a software system, comprising:
a memory that stores computer-readable code; and
a processor operatively coupled to said memory, said processor configured to implement said computer-readable code, said computer-readable code configured to:
collect details associated with a program task associated with said software system; and
provide said collected details for analysis.

33. A system for tracing details associated with a program task executing in a software system, comprising:
a memory that stores computer-readable code; and
a processor operatively coupled to said memory, said processor configured to implement said computer-readable code, said computer-readable code configured to:
monitor said software system to identify said program task; and
trace details associated with said program task.

34. An article of manufacture for analyzing behavior of a software system, comprising:
a computer readable medium having computer readable code means embodied thereon, said computer readable program code means comprising:
a step to collect details associated with a program task associated with said software system; and
a step to provide said collected details for analysis.

35. An article of manufacture for tracing details associated with a program task executing in a software system, comprising:
a computer readable medium having computer readable code means embodied thereon, said computer readable program code means comprising:
a step to monitor said software system to identify said program task; and
a step to trace details associated with said program task.
